(19) United States
(12) Patent Application Publication
(10) Pub. No.: US 2025/0239681 A1
(43) Pub. Date: Jul. 24, 2025

(54) POWER STORAGE DEVICE AND METHOD OF MANUFACTURING OF POWER STORAGE DEVICE

(71) Applicant: TOYOTA JIDOSHA KABUSHIKI KAISHA, Toyota-shi (JP)

(72) Inventors: Osamu YAMASHITA, Toyota-shi (JP); Kentaro Asanuma, Okazaki-shi (JP)

(73) Assignee: TOYOTA JIDOSHA KABUSHIKI KAISHA, Toyota-shi (JP)

(21) Appl. No.: 18/979,751

(22) Filed: Dec. 13, 2024

(30) Foreign Application Priority Data
Jan. 23, 2024 (JP) 2024-007859

(51) Int. Cl. H01M 10/6554; H01M 10/0525; H01M 10/058; H01M 10/613; H01M 10/6552; H01M 50/204; H01M 50/244

(52) U.S. Cl. CPC H01M 10/6554; H01M 10/058; H01M 10/613; H01M 10/6552; H01M 50/204; H01M 50/244; H01M 10/0525

(57) ABSTRACT

A power storage device includes power storage modules, a housing case accommodating the power storage modules, and a plate-like member placed on an outer wall of the housing case. The outer wall of the housing case and the plate-like member form a coolant passage through which a coolant is allowed to circulate.

### CROSS REFERENCE TO RELATED APPLICATIONS

This nonprovisional application is based on Japanese Patent Application No. 2024-007859 filed on Jan. 23, 2024 with the Japan Patent Office, the entire content of which is hereby incorporated by reference.

### BACKGROUND

The present disclosure relates to a power storage device and a method of manufacturing the power storage device.

### DESCRIPTION OF THE BACKGROUND ART

For example, Japanese Patent Laying-Open No. 2023-046659 discloses a power storage device having a structure requiring an assembly of a pre-manufactured cooler and a housing case with an outer thermally conductive layer in between, wherein the cooler is connected to a flow pipe horizontally extending from an end of the cooler.

### SUMMARY

Since the power storage device disclosed in Japanese Patent Laying-Open No. 2023-046659 has the structure requiring the cooler manufacturing steps and the steps of assembly of the cooler and the housing case, working efficiency is poor and a large part count is required.

The present disclosure is made to solve problems as stated above, and an object of the present disclosure is to provide a power storage device which includes a cooling device and has a structure requiring fewer manufacturing steps and a fewer part count.

The power storage device according to a first aspect of the present disclosure includes: power storage modules; a housing case accommodating the power storage modules; and a plate-like member placed on an outer wall portion of the housing case. The outer wall portion of the housing case and the plate-like member form a coolant passage through which a coolant is allowed to circulate.

With this configuration, the outer wall portion of the housing case and the plate-like member placed on the outer wall portion form the coolant passage through the coolant is allowed to circulate. As a result, there is no need to, previously, separately manufacture the cooler, and the manufacturing steps and the part count can be reduced, as compared to a conventional power storage device.

In the power storage device according to the first aspect of the present disclosure, the outer wall portion is formed in a flat surface. The plate-like member has a groove formed apart from the outer wall portion, and the coolant passage is formed between the groove and the outer wall portion.

In the power storage device according to the first aspect of the present disclosure, the groove formed in the plate-like member and the outer wall portion form the coolant passage. With this configuration, the plate-like member having the groove and the housing case can readily form the coolant passage.

The power storage device according to the first aspect of the present disclosure further includes a flow pipe which is in communication with the coolant passage and through which the coolant circulates. The housing case includes a bottom and a surrounding wall portion extending upward from an outer peripheral edge of the bottom. The outer peripheral edge of the bottom has recesses receding upward. The plate-like member includes a main unit located underneath the bottom, and cover portions extending upward from the main unit and covering the recesses. The flow pipe is connected to the cover portions and extends in a horizontal direction.

In the power storage device according to the first aspect of the present disclosure, the recesses receding upward are formed in the outer peripheral edge of the housing case the bottom, as stated above. The flow pipe is configured to be horizontally connected to the power storage device. The flow pipe has ends in communication with spaces formed by the recesses. With this configuration, the flow pipe is allowed to have a pipe diameter corresponding to the open areas of the recesses, as with the embodiments according to the present disclosure. As a result, the pressure loss of the coolant can be reduced. Moreover, the flow pipe can be prevented from being the lowermost part of the vehicle. As a result, an increased height of the vehicle can be reduced.

The cover portions of the power storage device according to the first aspect of the present disclosure are formed to cover portions of the surrounding wall portion located around the recesses.

Since the cover portion has no groove, the cover portion has a small second moment of inertia, as compared to the main unit. Accordingly, as a load is applied to the cover portion, the cover portion is readily positioned along the housing case. With this configuration, there is no need to bend the cover portion of the plate-like member prior to the joining step, allowing the power storage device to be provided, requiring fewer manufacturing steps.

The power storage device according to the first aspect of the present disclosure further includes electrical equipment placed within the housing case, wherein the electrical equipment is placed above the recesses of the housing case.

With this configuration, the recesses formed in the housing case allows electrical equipment to be placed in the space that is unable to accommodate the power storage modules. As a result, the space is effectively used.

A method of manufacturing a power storage device according to a second aspect of the present disclosure includes: placing a plate-like member on an outer wall portion of a housing case, the plate-like member having a groove formed apart from the outer wall portion; placing a first electrode material within the housing case; placing the second electrode material on a plate-like member side; joining the housing case and the plate-like member by a heat generated by passing a current between the first electrode material and the second electrode while the first electrode material and the second electrode material are applying pressures to the housing case and the groove edge of the groove. The joining includes joining the housing case and the plate-like member linearly by a rotation of the first electrode material, an outer periphery of the first electrode material includes a round arc portion and a linear portion, and the second electrode material has recesses corresponding to the groove and covering the entirety of the groove.

The first electrode material, which includes the round arc portion and the linear portion, forms a linear welding line by rotating. The thus configured first electrode material can prevent the first electrode material from interfering with the surrounding wall portion at the corners of the housing case. This allows formation of a welding line at the corners of the housing case too.

The second electrode material is placed below the first electrode material with the housing case and the plate-like member in between. The second electrode material is formed to cover the entirety of the groove formed in the plate-like member. The second electrode material also has recesses corresponding to the groove. The thus configured second electrode material has a large heat capacity, as compared to the electrode separately formed via the groove. As a result, the second electrode material can be prevented from being melted by the heat during resistance welding.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing a vehicle having a power storage device according to an embodiment according to the present disclosure mounted thereon.

FIG. 2 is a perspective view schematically showing the power storage device according to the embodiment.

FIG. 3 is an exploded perspective view of the power storage device of FIG. 2.

FIG. 4 is the exploded perspective view of the power storage device FIG. 3 as viewed from below.

FIG. 5 is a flow diagram illustrating steps for manufacturing the power storage device according to the embodiment.

FIG. 6 is a schematic view showing a placing step for manufacturing the power storage device according to the embodiment.

FIG. 7 is a schematic view showing a first joining step for manufacturing the power storage device according to the embodiment.

FIG. 8 is a cross-sectional view of the power storage device taken along an IX-IX cross section of FIG. 7.

FIG. 9 is a schematic view showing a second joining step for manufacturing the power storage device according to the embodiment.

FIG. 10 is an exploded perspective view of the power storage device according to Variation 1 of the embodiment.

FIG. 11 is an exploded perspective view of the power storage device according to Variation 2 of the embodiment.

FIG. 12 is an exploded perspective view of the power storage device according to Variation 3 of the embodiment.

### DESCRIPTION OF THE PREFERRED EMBODIMENTS

Embodiments according to the present disclosure will be described, with reference to the accompanying drawings. Referring now to the drawings wherein like numerals are used to refer to like or corresponding members.

### Configuration of Power Storage Device

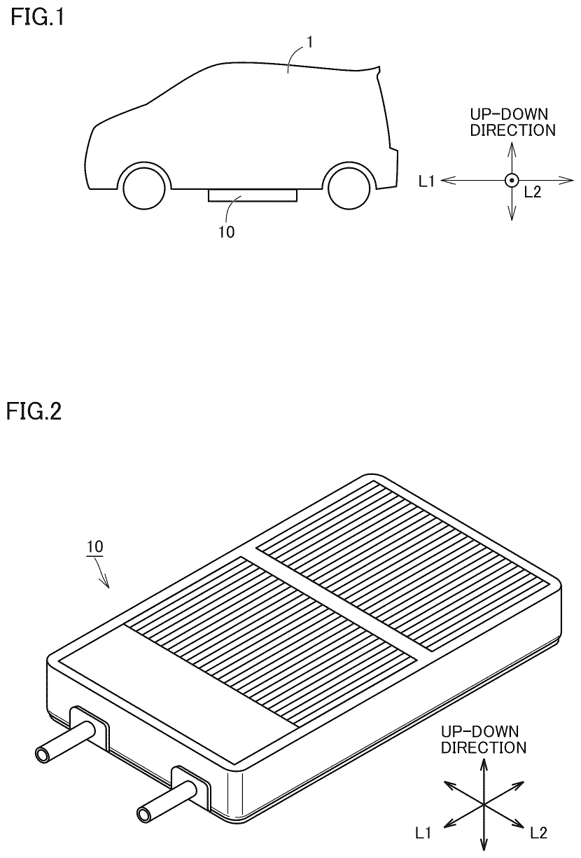

FIG. 1 is a diagram schematically showing a vehicle having a power storage device according to the present embodiment mounted thereon. A power storage device 10 is mounted underneath a vehicle 1, for example. Note that, in FIG. 1, etc., a first direction L1 indicates the front-rear direction of the vehicle 1, and a second direction L2 indicates the track width direction of the vehicle 1.

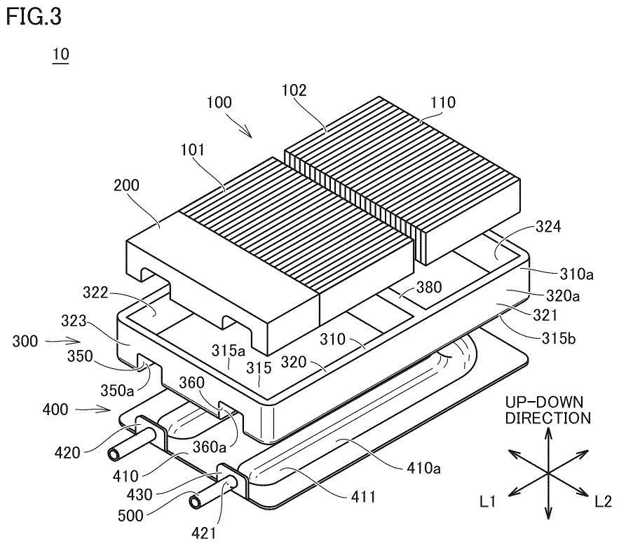

FIG. 2 is a perspective view schematically showing the power storage device according to the present embodiment. FIG. 3 is an exploded perspective view of the power storage device of FIG. 2.

As shown in FIG. 3, the power storage device 10 includes a power storage unit 100, electrical equipment 200, a housing case 300, a plate-like member 400, and a flow pipe 500. In FIGS. 2 and 3, the upper cover of the housing case 300 is not shown. The power storage unit 100 and the electrical equipment 200 are accommodated within the housing case 300. The power storage unit 100 has a power storage module 101 and a power storage module 102.

The power storage modules 101 and 102 each have multiple power storage cells 110 that are aligned in the second direction L2. The power storage cells 110 are elongated in the first direction L1. The power storage cells 110 are, for example, lithium-ion batteries.

The electrical equipment 200 has recesses corresponding to recesses 350 and 360 that are formed in the housing case 300 described below. The electrical equipment 200 is placed above the recesses 350 and 360 formed in the housing case 300. The electrical equipment 200 is, for example, a junction box. With this configuration, the recess 350 allows effective use of the space that is unable to accommodate the power storage unit 100.

The housing case 300 has an outer wall 310 and a partitioning wall 380.

The outer wall 310 is formed open upward. The outer wall 310 includes a bottom 315, a surrounding wall portion 320, and the recesses 350 and 360. The outer wall 310 has an outer wall surface 310a formed of a bottom surface 315a of the bottom 315, a surrounding wall surface 320a of the surrounding wall portion 320, and inner peripheral surfaces 350a and 360a of the recesses 350 and 360.

The bottom 315 is formed in a rectangular flat surface. The power storage unit 100 is placed on and above the bottom 315.

The surrounding wall portion 320 extends upward from an outer peripheral edge 315b of the bottom 315. The surrounding wall portion 320 includes long wall portions 321 and 322 and end wall portions 323 and 324.

The long wall portions 321 and 322 are elongated in the first direction L1 and spaced apart from each other in the second direction L2.

The end wall portions 323 and 324 are placed, spaced apart from each other in the first direction L1. Note that the lengths of the end wall portions 323 and 324 in the second direction L2 are shorter than the lengths of the long wall portions 321 and 322 in the first direction L1.

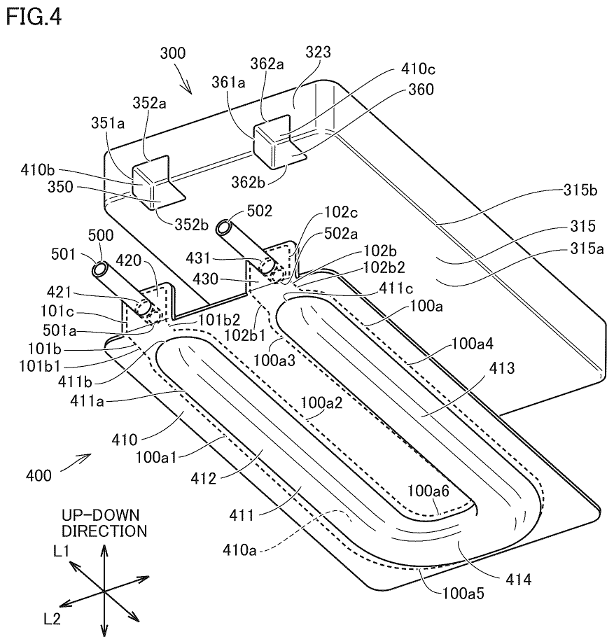

FIG. 4 is a diagram showing the exploded perspective view of the power storage device of FIG. 3 as viewed from below. For convenience, the power storage unit 100 is not shown.

The recesses 350 and 360 are formed in the outer peripheral edge 315b of the bottom 315. Specifically, the recesses 350 and 360 are formed at boundaries between the bottom 315 and the end wall portion 323. Note that the recess 350 and the recess 360 are formed, spaced apart from each other in the second direction L2. The recesses 350 and 360 recede upward from the bottom 315.

The recess 350 has an open edge 351a formed of an edge 352a located at the end wall portion 323 and an edge 352b located at the bottom 315.

The recess 360 has an open edge 361a formed of an edge 362a located at the end wall portion 323 and an edge 362b located at the bottom 315.

Referring, again, to FIG. 3, the partitioning wall 380 is formed on the bottom 315. The partitioning wall 380 extends in the second direction L2 and has opposing ends connected to the long wall portion 321 and the long wall portion 322. The partitioning wall 380 is placed to separate the power storage modules 101 and 102 in the first direction L1. The upper surface of the partitioning wall 380 and the upper surface of the surrounding wall portion 320 are flush with each other.

Referring, again, to FIG. 4, the plate-like member 400 is placed underneath the bottom 315. The plate-like member 400 includes a main unit 410 and cover portions 420 and 430.

The main unit 410 is placed underneath the bottom 315. The main unit 410 forms the entirety of the lower portions of the power storage modules 101 and 102 accommodated in the housing case 300. Note that the edges 352b and 362b are covered with the main unit 410.

The main unit 410 has a groove 411 formed therein apart from the bottom 315. The groove 411 has one edge 411b below the recess 350 formed in the bottom 315. The groove 411 has the other edge 411c below the recess 360 in the bottom 315.

The groove 411 is formed in one piece across the main unit 410. The groove 411 is formed in U shape. The groove 411 includes a long groove 412, a long groove 413, and a connecting groove 414.

The long groove 412 and the long groove 413 extend in the first direction L1 and are spaced apart from each other in the second direction L2.

The connecting groove 414 connects the long groove 412 and the long groove 413.

The cover portion 420 and the cover portion 430 are aligned, spaced apart from each other in the second direction L2. The cover portion 420 extends upward from an edge of the main unit 410. The cover portion 420 covers the recess 350. More specifically, the cover portion 420 covers the edge 352a and a portion of the end wall portion 323 located around the edge 352a. The cover portion 420 has an opening 421.

The cover portion 430 extends upward from the edge of the main unit 410. The cover portion 430 covers the recess 360. More specifically, the cover portion 430 covers the edge 362a and a portion of the recess 360 located around the edge 362a. The cover portion 430 has an opening 431.

The groove 411 and the bottom 315 form a coolant passage 410a. As the cover portion 420 covers the edge 352a and the main unit 410 covers the edge 352b, a space 410b is formed. The space 410b and one end of the coolant passage 410a are in communication.

As the cover portion 430 covers the edge 362a and the main unit 410 covers the edge 362b, a space 410c is formed. The space 410c and the other end of the coolant passage 410a are in communication.

The flow pipe 500 extends in the first direction L1. The flow pipe 500 has an inflow pipe 501 and an outflow pipe 502. The inflow pipe 501 has an end 501a in communication with the space 410b through the opening 421. The flow pipe 501 and the opening 421 are sealed by welding. The outflow pipe 502 has an end 502a in communication with the space 410c through the opening 431. The outflow pipe 502 and the opening 431 are sealed by welding.

The plate-like member 400 and the housing case 300 are joined together by welding lines 100a, 101b, 102b, 101c, and 102c.

The welding line 100a includes an outer portion 100a1, an inner portion 100a2, an inner portion 100a3, an outer portion 100a4, an outer portion 100a5, and an inner portion 100a6.

The outer portion 100a1 extends along the outer peripheral edge outside the long groove 412, and the inner portion 100a2 extends along the inner peripheral edge inside the long groove 412.

Similarly, the inner portion 100a3 extends along the inner peripheral edge inside the long groove 413, and the outer portion 100a4 extends along the outer peripheral edge outside the long groove 413.

The outer portion 100a5 extends along the outer peripheral edge outside the connecting groove 414, and the inner portion 100a6 extends along the inner peripheral edge inside the connecting groove 414.

The welding line 101b includes an outer portion 101b1 and an inner portion 101b2.

The outer portion 101b1 extends in the first direction L1, connecting the outer portion 100a1 and the welding line 101c.

The inner portion 101b2 extends in the first direction L1, connecting the inner portion 100a2 and the welding line 101c.

The welding line 102b includes an inner portion 102b1 and an outer portion 102b2.

The inner portion 102b1 extends in the first direction L1, connecting the inner portion 100a3 and the welding line 102c.

The outer portion 102b 2 extends in the first direction L1, connecting the outer portion 100a4 and the welding line 101c.

The welding line 101c is formed along the edge 352a. The welding line 102c is formed along the edge 362a.

In the vehicle 1 having the power storage device 10 configured as the above mounted thereon, as the vehicle 1 travels, the power storage device 10 repeats charging and discharging power. As a result, the power storage device 10 generates heat.

Meanwhile, as a coolant C flows into the space 410b through the inflow pipe 501, and, thereafter, flows into the coolant passage 410a, the coolant C cools the power storage modules 101 and 102. Then, the coolant C flows into the space 410c, and is thereafter discharged through the outflow pipe 502. In this manner, the coolant C circulates through the coolant passage 410a, thereby, cooling the power storage modules 101 and 102 well.

### Method of Manufacturing Power Storage Device

Next, one example of a method of manufacturing the power storage device 10 is described, with reference to FIGS. 5 to 8. FIG. 5 is a flowchart showing a method of manufacturing the power storage device 10 according to the present embodiment. As shown in FIG. 5, the steps for manufacturing the power storage device 10 include a placing step S1, a first joining step S2, and a second joining step S3.

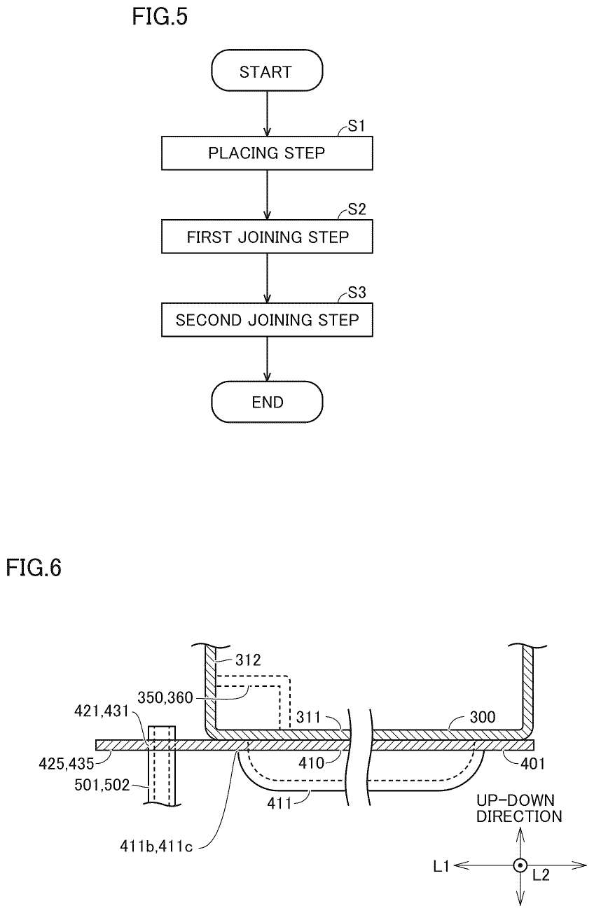

The placing step S1 is now described with respect to FIG. 6. FIG. 6 is a schematic view showing a placing step for manufacturing the power storage device according to the present embodiment. In the placing step S1, the plate-like member 401 is placed underneath the housing case 300. The plate-like member 401 has the main unit 410, a cover portion 425, and a cover portion 435.

The edge 411b of the groove 411 formed in the main unit 410 is placed below the recess 350. Similarly, the edge 411c is placed below the recess 360.

The cover portion 425 and the cover portion 435 are flush with the main unit 410. The cover portion 425 and the cover portion 435 are connected to the edge of the main unit 410. The cover portion 425 and the cover portion 435 are aligned, spaced apart from each other in the second direction L2.

The inflow pipe 501 is inserted in the cover portion 425 through the opening 421. The inflow pipe 501 is welded with the opening 421.

The inflow pipe 502 is inserted in the cover portion 435 through the opening 431. The outflow pipe 502 is welded with the opening 431.

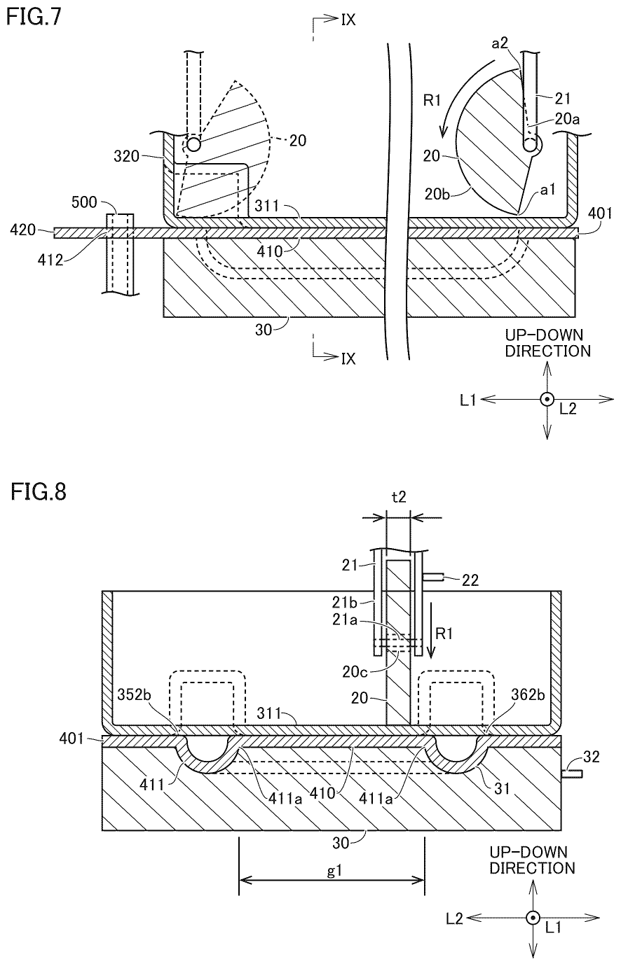

Referring to FIGS. 7 and 8, the first joining step S2 is now described. FIG. 7 is a schematic view showing the first joining step for manufacturing the power storage device according to the present embodiment. FIG. 8 is a cross-sectional view taken along an IX-IX cross section of FIG. 7. Initially, referring to FIG. 7, in the first joining step S2, the bottom 315 of the housing case 300 and the main unit 410 of the plate-like member 401 are joined by the welding lines 100a, 101b, and 101c of FIG. 5. The joining is, for example, welding by well-known seam welding. The first joining step S2 includes a step of placing a first electrode material 20 inside the housing case 300, and a step of placing a second electrode material 30 underneath the plate-like member 400.

The first electrode material 20 is formed in a notched disc shape, as viewed from the second direction L2, and configured of at least one linear line 20a and a round arc 20b. Next, referring to FIG. 8, the first electrode material 20 has a thickness t2. The first electrode material 20 has a bearing 20c at the core of a circle partially having the round arc 20b. The first electrode material 20 is supported by a support member 21.

The support member 21 has a shaft 21a passing through the bearing 20c, and a pair of bars 21b. A terminal 22 for connection to a power supply is formed in the support member 21. The first electrode material 20 and the terminal 22 are conducting.

The first electrode material 20 transfer a vertical load, received from the support member 21, to the bottom 315. The first electrode material 20 also rotates in a circumference direction R1 by the horizontal load received from the support member 21 and the friction force received from the bottom 315. The first electrode material 20 starts rotating at a start point a1 and stops rotating at an end point a2. The first electrode material 20 starts rotating again at the start point a1 originating from the destination of the end point a2. Repeating this cycle, the first electrode material 20 moves on the welding lines 100a, 101b, and 102b of FIG. 4.

The second electrode material 30 is placed underneath the plate-like member 401. The second electrode material 30 is formed in one piece to cover the groove edge 411a, and the entirety of the edges 352b and 362b via the main unit 410. The second electrode material 30 may be formed to cover the main unit 410. The second electrode material 30 has a recess 31 corresponding to the groove 411. The second electrode material 30 is placed on a base or the like (now shown) and receives a reaction force of the load applied by the first electrode material 20 to the bottom 315. The second electrode material 30 has a terminal 32.

With this configuration, the first electrode material 20 and the second electrode material 30 can apply pressures to the bottom 315 and the groove edge 411a. Furthermore, passing a current between the first electrode material 20 and the second electrode material 30 via the terminals 22 and 32 can generate Joule heat between the bottom 315 and the groove edge 411a, which is caused by an electric resistance. The application of the pressures and Joule heat join the bottom 315 and the groove edge 411a together. As the first electrode material 20 rotationally moves in the circumference direction R1, a welding portion is formed in a linear shape, resulting in the welding line 100a.

Similarly, the first electrode material 20 and the second electrode material 30 can join the bottom 315 and the edges 352b and 362b together. This results in formation of the welding lines 101b and 102b.

The first electrode material 20 is formed in a notched disc shape configured of the linear line 20a and the round arc 20b. With this configuration, in the course of forming the welding lines 100a, 101b, and 102b of FIG. 4, the first electrode material 20 and the surrounding wall portion 320 can be prevented from interfering with each other, as indicated by the dashed lines of FIG. 7.

In FIG. 8, the second electrode material 30 formed in one piece and having the recess 31 is placed underneath the plate-like member 400. With this configuration, the second electrode material 30 can be brought into contact with the main unit 410, irrespective of a gap g1 between adjacent groove edges 411a.

For example, when the first electrode material 20 is placed underneath the plate-like member 400, instead of the second electrode material 30, the first electrode material 20 interferes with the groove 411 if the thickness t2 of the first electrode material 20 is greater than the gap g1 between the adjacent groove edges 411a. As a result, the first electrode material 20 can not be brought into contact with the groove edge 411a, and the bottom 315 and the plate-like member 400 cannot be joined together. In the embodiment of the present disclosure, this is solved by placing the second electrode material 30 underneath the plate-like member 400.

Moreover, the thus configured second electrode material 30 has a large heat capacity, as compared to electrodes separately formed apart from each other by the groove 411. As a result, the electrode materials can be prevented from being melted by the heat caused by the electric resistance.

In the above example, the second electrode material 30 is formed in one piece. However, the present disclosure is not limited thereto. For example, the second electrode material 30 may be formed of multiple electrode materials that can cover the edges 352b and 362b via the groove edge 411a and the main unit 410.

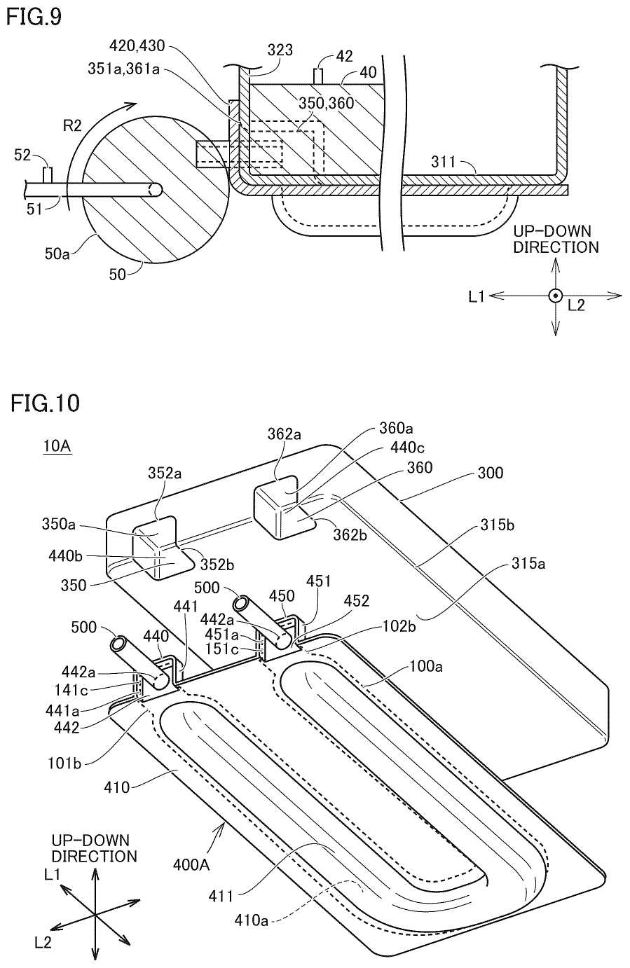

The second joining step S3 is now described with reference to FIG. 9. FIG. 9 is a schematic view showing the second joining step for manufacturing the power storage device according to the present embodiment. In the second joining step S3, the end wall portion 323 and the cover portions 420 and 430 of the plate-like member 401 are joined by the welding lines 101c and 102c of FIG. 4. The joining is, for example, welding by well-known seam welding. The second joining step S3 includes a step of placing a third electrode material 40 inside the housing case 300, and a step of placing a fourth electrode material 50 underneath the plate-like member 401.

The third electrode material 40 has recesses corresponding to the shapes of the recesses 350 and 360 formed in the outer wall 310. The third electrode material 40 may be formed to cover, from inside the housing case, portions of the end wall portion 323 located around the open edges 351a and 361a. The third electrode material 40 has a terminal 42 connected to a power supply.

The fourth electrode material 50 is formed in a disc shape. The fourth electrode material 50 is held by a support member 51. The support member 51 has the same structure as the support member 21. The support member 51 has a terminal 52 formed to be connected to a power supply. The fourth electrode material 50 applies, to the plate-like member 401, a load in a direction perpendicular from the support member 51 to the housing case 300. The fourth electrode material 50 also rotationally moves in a circumference direction R2 by a load horizontal to the housing case 300 and received from the support member 51 and the friction force received from the plate-like member 400.

With this configuration, the plate-like member 401 can be processed, by the third electrode material 40 and the fourth electrode material 50, to have the shape of the plate-like member 400. Specifically, as the fourth electrode material 50 rotationally moves in the circumference direction R2 upward from the boundary between the main unit 410 and the cover portion 425 onto the cover portion 425, thereby changing the shape of the cover portion 425 to be one (the cover portion 420) matching the end wall portion 323. The same is true for the cover portion 435. Furthermore, passing a current between the third electrode material 40 and the fourth electrode material 50 can generate Joule heat between the end wall portion 323 and the cover portions 420 and 430, which is caused by an electric resistance. The application of the pressures and Joule heat joins the end wall portion 323 and the cover portions 420 and 430 together. At this time, the fourth electrode material 50 rotationally moves in the circumference direction R2, and a welding portion is, thereby, formed in a linear shape, resulting in a welding line 100c.

Configuring the cover portions 420 and 430 to wrap around the edges 352a and 362a of the end wall portion 323 allows the fourth electrode material 50 to move on the welding line 100c, without interfering with the flow pipe 500.

the power storage device 10 is manufactured by the above steps.

According to the embodiment of the present disclosure, the bottom 315 of the housing case 300 formed in one piece and open upward and the groove 411 in the plate-like member 400 form the coolant passage 410a. With this configuration, there is no need to, previously, separately manufacture the cooler having the coolant passage, and the manufacturing steps and the part count can be reduced, as compared to a conventional power storage device.

In the above example, the housing case 300 and the plate-like member 400 placed underneath the bottom 315 of the housing case 300 form the coolant passage 410a. However, the present disclosure is not limited thereto. For example, the surrounding wall surface 320a in the form of a flat surface and the plate-like member 400 that is placed on the surrounding wall surface 320a may form the coolant passage. This allows the power storage modules 101 and 102 accommodated within the housing case 300 to be cooled from side surfaces.

In the above example, 350 and 360 are formed, spaced apart from each other in the second direction. However, the present disclosure is not limited thereto. For example, only one recess may be provided.

### Variation 1 of Power Storage Device

In the above example, the power storage device 10 includes the housing case 300 and the plate-like member 400. However, the present disclosure is not limited thereto.

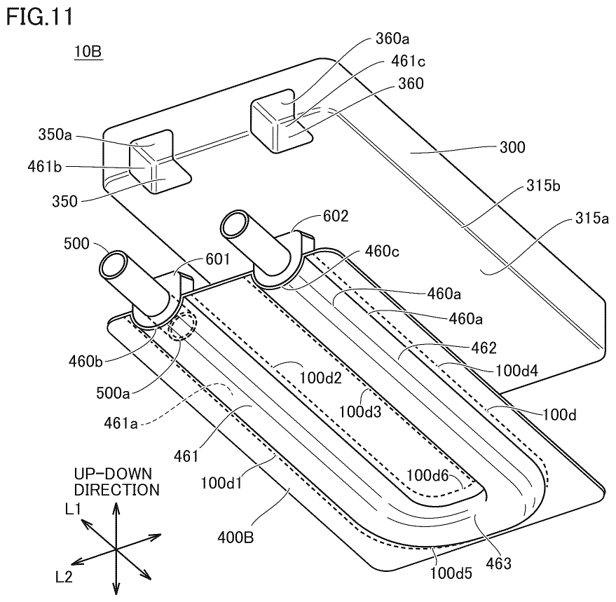

For example, first, a power storage device 10A may include the housing case 300 and a plate-like member 400A, as shown in FIG. 10.

The plate-like member 400A is placed underneath the housing case 300. The outline of the plate-like member 400A coincides with the outer peripheral edge 315b.

The plate-like member 400A includes the main unit 410 and cover portions 440 and 450. The cover portion 440 and the cover portion 450 are arranged, spaced apart from each other in the second direction L2.

The cover portion 440 extends upward from an edge of the plate-like member 400A. The cover portion 440 has a surrounding wall portion 441 and a side wall portion 442. The surrounding wall portion 441 is formed along the inner peripheral surface 350a of the recess 350. The side wall portion 442 has an opening 442a. The flow pipe 500 passes through the opening 442a.

The cover portion 450 is, similarly, extends upward from an edge of the plate-like member 400A. The cover portion 450 has a surrounding wall portion 451 and a side wall portion 452. The surrounding wall portion 451 is formed along the inner peripheral surface 360a of the recess 360. The side wall portion 452 has an opening 452a. The flow pipe 500 passes through the opening 452a.

The groove 411 and the bottom surface 315a form the coolant passage 410a. The surrounding wall portion 441 covers the inner peripheral surface 350a along the edge 352a, and the space 440b is, thereby, formed. The surrounding wall portion 451 covers the inner peripheral surface 360a along the edge 362a and the space 440c is, thereby, formed.

The coolant passage 410a has one end in communication with the space 440b, and the other end in communication with the space 450b.

In the power storage device 10A, the bottom 315 and the plate-like member 400A are joined by the welding lines 100a, 101b, 102b, 141c, and 151c. The welding lines 100a, 101b, and 102b are as described above.

The welding line 141c is formed on the surrounding wall surface 441a of the surrounding wall portion 441 along the edge 352a and connected to the welding line 101b.

Similarly, the welding line 151c is formed on the surrounding wall surface 451a of the surrounding wall portion 451 along the edge 362a and connected to the welding line 102b.

### Variation 2 of Power Storage Device

For example, second, a power storage device 10B may include the housing case 300 and a plate-like member 400B, as shown in FIG. 11. The plate-like member 400B is placed underneath the housing case 300. The outline of the plate-like member 400B coincides with the outer peripheral edge 315b.

The plate-like member 400B has a groove 460. The groove 460 is formed apart from the bottom surface 315a.

The groove 460 is formed in U shape. The groove 460 includes a long groove 461, a long groove 462, and a connecting groove 463. The long groove 461 and the long groove 462 extend in the first direction L1 and are spaced apart from each other in the second direction L2. The connecting groove 463 connects the long groove 461 and the long groove 462.

The groove 460 is open below the recess 350 and at an edge 460b of the plate-like member 400B. The groove 460 is open below the recess 360 and at an edge 460c of the plate-like member 400B. The edge 460b and the edge 460c are arranged, spaced apart from each other in the second direction L2.

The flow pipe 500 passes through seals 601 and 602. The flow pipe 500 has ends 500a in communication with spaces 461b and 461c.

The groove 460 and the bottom surface 315a form a coolant passage 461a. The seal 601 creates a seal between the edge 460b and the inner peripheral surface 350a and the space 461b is, thereby, formed. Similarly, the seal 602 creates a seal between the edge 460c and inner peripheral surface 360a and the space 461c is, thereby formed.

The coolant passage 461a has one end in communication with the space 461b, and the other end in communication with the space 461c.

In the power storage device 10B, the bottom 315 and the plate-like member 400B are joined by the welding line 100d.

The welding line 100d includes an outer portion 100d1, an inner portion 100d2, an inner portion 100d3, an outer portion 100d4, an outer portion 100d5, an inner portion 100d6.

The outer portion 100d1 extends along the outer peripheral edge outside the long groove 461, and the inner portion 100d2 extends along the inner peripheral edge inside the long groove 461.

Similarly, the inner portion 100d3 extends along the inner peripheral edge inside the long groove 462, and the outer portion 100d4 extends along the outer peripheral edge outside the long groove 462.

The outer portion 100d5 extends along the outer peripheral edge outside the connecting groove 463, and the inner portion 100d6 extends along the inner peripheral edge inside the connecting groove 463.

### Variation 3 of Power Storage Device

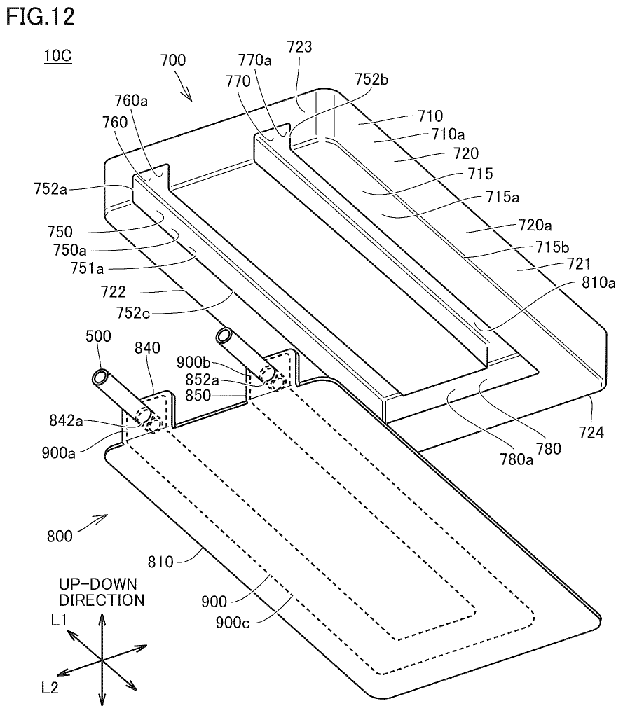

For example, last, a power storage device 10C may include a housing case 700 and a plate-like member 800, as shown in FIG. 12.

The housing case 700 has an outer wall 710.

The outer wall 710 is formed to open upward. The outer wall 710 includes a bottom 715, a surrounding wall portion 720, and a recess 750. The recess 750 includes recesses 760, 770, and 780.

The outer wall 710 has an outer wall portion 710a which includes a bottom surface 715a of the bottom 715, a surrounding wall surface 720a of the surrounding wall portion 720, and an inner peripheral surface 750a of the recess 750. The inner peripheral surface 750a includes inner peripheral surfaces 760a, 770a, and 780a of the recess 760, 770, and 780.

The bottom 715 is formed in a rectangular flat surface. The power storage unit 100 is placed on and above the bottom 715.

The surrounding wall portion 720 extends upward from an outer peripheral edge 715b of the bottom 715. The surrounding wall portion 720 includes long wall portions 721 and 722 and end wall portions 723 and 724.

The long wall portions 721 and 722 are elongated in the first direction L1, and placed, spaced apart from each other in the second direction L2.

The end wall portions 723 and 724 are placed, spaced apart from each other in the first direction L1. The end wall portions 723 and 724 are elongated in the second direction L2. Note that the lengths of the end wall portions 723 and 724 in the second direction L2 are longer than the lengths of the long wall portions 721 and 722 in the first direction L1.

The recesses 760, 770, and 780 recede into the bottom 715. The recesses 760 and 770 extend in the first direction L1. The recess 780 extends in the second direction L2. The recess 760 and the recess 770 are spaced apart from each other in the second direction L2. One end of the recess 760 and one end of the recess 770 are open at the end wall portion 723. The recess 780 connects the other end of the recess 760 and the other end of the recess 770.

An open edge 751a of the recess 750 includes edges 752a and 752b located at the end wall portion 723 and an edge 752c located at the bottom 715.

The plate-like member 800 is placed underneath the housing case 700. The outline of the plate-like member 800 coincides with the outer peripheral edge 715b.

The plate-like member 800 includes a main unit 810 and cover portions 840 and 850. The cover portion 840 and the cover portion 850 are arranged, spaced apart from each other in the second direction L2. The cover portions 840 and 850 extend upward from an end of the plate-like member 800. The cover portion 840 and the cover portion 850 have an opening 842a and an opening 852a, respectively. The flow pipe 500 passes through the openings 842a and 852a.

The recess 750 and the plate-like member 800 forms a coolant passage 810a. More specifically, the coolant passage 810a is formed by the main unit 810 covering the bottom surface 715a, the cover portion 840 covering the edge 752a of the end wall portion 723 and a portion of the end wall portion 723 located around 752a, and the cover portion 850 covering the edge 752b of the end wall portion 723 and a portion of the end wall portion 723 located around 752b.

In the power storage device 10C, the bottom 715 and the plate-like member 800 are joined by a welding line 900. The welding line 900 includes welding lines 900a, 900b, and 900c.

The welding line 900a is formed to be along the edge 752a and connected to the welding line 900c.

The welding line 900b is formed to be along the edge 752b and connected to the welding line 900c.

The welding line 900c is formed to be along the edge 752c and connected to the welding lines 900a and 900b.

The power storage device configured as shown in FIGS. 10, 11, and 12 allows the flow pipe to have a pipe diameter corresponding to the open areas of the recesses, as with the embodiments according to the present disclosure. As a result, the pressure loss of the coolant can be reduced. Moreover, horizontally connecting the flow pipe to the power storage device can avoid the flow pipe from being the lowermost part of the vehicle. As a result, an increased height of the vehicle can be reduced.

While the embodiments according to the present disclosure have been described above, the presently disclosed embodiments should be considered in all aspects illustrative and not restrictive. The scope of the present disclosure is defined by the appended claims. All changes which come within the meaning and range of equivalency of the appended claims are to be embraced within their scope.

What is claimed is:

1. A power storage device, comprising:
power storage modules;
a housing case accommodating the power storage modules; and
a plate-like member placed on an outer wall surface of the housing case, wherein,
the outer wall surface of the housing case and the plate-like member form a coolant passage through which a coolant is allowed to circulate.

2. The power storage device according to claim 1, wherein
the outer wall surface is formed in a flat surface,
the plate-like member has a groove formed apart from the outer wall surface, and
the coolant passage is formed between the groove and the outer wall surface.

3. The power storage device according to claim 1, further comprising
a flow pipe which is in communication with the coolant passage and through which the coolant circulates, wherein
the housing case includes a bottom and a surrounding wall portion extending upward from an outer peripheral edge of the bottom,
the outer peripheral edge of the bottom has recesses receding upward,
the plate-like member includes a main unit located underneath the bottom, and cover portions extending upward from the main unit and covering the recesses, and
the flow pipe is connected to the cover portions and extends in a horizontal direction.

4. The power storage device according to claim 3, wherein
the cover portions are formed to cover portions of the surrounding wall portion located around the recesses.

5. The power storage device according to claim 1, further comprising
electrical equipment placed within the housing case, wherein
the electrical equipment is placed above the recesses of the housing case.

6. A method of manufacturing a power storage device, the method comprising:
placing a plate-like member on an outer wall surface of a housing case, the plate-like member having a groove formed apart from the outer wall surface;
placing a first electrode material within the housing case;
placing a second electrode material on a plate-like member side; and
joining the housing case and the plate-like member by a heat generated by passing a current between the first electrode material and the second electrode material while the first electrode material and the second electrode material are applying pressures to the housing case and a groove edge of the groove, wherein
the joining includes joining the housing case and the plate-like member linearly by a rotation of the first electrode material,
an outer periphery of the first electrode material includes a round arc portion and a linear portion, and
the second electrode material has recesses corresponding to the groove and covering the groove.
